(19) United States
(12) Patent Application Publication
(10) Pub. No.: US 2010/0157963 A1
(43) Pub. Date: Jun. 24, 2010

(54) METHOD FOR PROVIDING MOBILITY TO MOBILE NODE IN PACKET TRANSPORT NETWORK, PACKET TRANSPORT NETWORK SYSTEM AND GATEWAY SWITCH

(75) Inventors: Chang Ho CHOI, Daejeon (KR); Yong Wook Ra, Daejeon (KR); Bheom Soon Joo, Daejeon (KR); Byung Jun Ahn, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/559,544

(22) Filed: Sep. 15, 2009

(30) Foreign Application Priority Data
Dec. 22, 2008 (KR) 10-2008-0131622

(51) Int. Cl. H04W 88/16; H04W 40/00; H04L 12/56

(52) U.S. Cl. 370/338; 370/401; 370/395.53

(57) ABSTRACT

A method for providing mobility of a mobile node in a packet transport network, and a packet transport network system are provided. The packet transport network system includes a plurality of gateway switches configured in a plurality of packet transport access networks to connect a packet transport core network and transmit/receive a packet to/from a certain terminal via a certain access switch. When the certain terminal moves, each gateway switch updates a tunnel mapping and management table according to the movement of the certain terminal, allocates a pre-set tunnel by using information included in the tunnel mapping and management table, and transmits/receives a packet to/from a counterpart terminal via the allocated tunnel. Thus, a packet loss and delay due to the influence of handover occurring when the mobile node moves between networks can be minimized and the handover procedure can be simplified.

### CROSS-REFERENCE TO RELATED APPLICATIONS

This application claims the priority of Korean Patent Application No. 2008-0131622 filed on Dec. 22, 2008, in the Korean Intellectual Property Office, the disclosure of which is incorporated herein by reference.

### BACKGROUND OF THE INVENTION

1. Field of the Invention

The present invention relates to providing of mobility of a mobile node in a packet transport network and, more particularly, to a method of providing mobility of a mobile node by setting and managing a tunnel via a gateway switch connecting a packet transport core network (PTCN) and a packet transport access network (PTAN) in a packet transport network, and to a packet transport network and a gateway switch.

2. Description of the Related Art

A mobile IP (Internet Protocol) providing the IP of a mobile node is able to maintain a current service ceaselessly by changing physical ports according to the movement of the mobile node in an IP-based network. Various nascent methods have been proposed as techniques for supporting the global IP mobility to mobile nodes, and among them, a mobile IP version 4 (MIPv4) and a mobile IP version 6 (MIPv6) standardized by IETF are typical methods. The MIPv6 provides generally improved functions compared with the existing MIPv4, but because it still has problems with handover delay and packet loss resulting from the changing of IP addresses, schemes for supplementing such shortcomings have been constantly proposed.

Another method of providing mobility to mobile nodes is performing a handover procedure at a link layer (L2), for which a lot of technologies have been proposed. However, the handover at the link layer provides mobility to mobile nodes only in certain areas, having a problem with extendibility. Namely, in the case of an access router in the related art packet transport network, mobility between access switches connected to the access router is possible, but there are many problems in providing mobility to mobile nodes according to movement between access routers.

### SUMMARY OF THE INVENTION

An aspect of the present invention provides a gateway switch for constituting a packet transport network by using an L2 switch for packet transmission and connecting a packet transport core and metro network and a plurality of local area packet transport access networks, and a packet transport network system having the gateway switch.

Another aspect of the present invention provides a method for effectively providing mobility of a mobile node by allowing a packet transport network system to establish and manage logical tunnels between gateway switches to thus minimize the influence of handover and simplify a handover procedure according to the movement of a mobile node.

According to an aspect of the present invention, there is provided a method for providing mobility of a mobile node by a gateway switch of one of a plurality of packet transport access networks each having a gateway switch to be connected to a core network in a packet transport network, the method including: transmitting/receiving a packet between the mobile node and a counterpart node via a first tunnel established with a gateway switch of a packet transport access network in which the counterpart node is located; transmitting a packet received via the first tunnel from the counterpart node to the mobile node; setting and managing a logical tunnel mapping and management table between different gateway switches according to the movement of the mobile node; establishing a second tunnel between a gateway switch of an adjacent packet transport access network to which the mobile node has moved and the gateway switch of the packet transport access network in which the counterpart node is located; and transmitting/receiving a packet between the mobile node and the counterpart node via the established second tunnel.

According to an aspect of the present invention, there is provided a packet transport network system including: a plurality of access switches configured in a plurality of packet transport access networks connected to a packet transport core network (PTCN) and transmitting/receiving a packet to/from a certain terminal; and a plurality of gateway switches configured in the plurality of packet transport access networks, connecting the packet transport access networks to the PTCN, and transmitting/receiving a packet to/from the certain terminal via a certain access switch, wherein each gateway switch includes a tunnel mapping and management table, and when the certain terminal moves, each gateway switch updates the tunnel mapping and management table according to the movement of the certain terminal and allocates a tunnel for transmitting/receiving a packet to/from a counterpart node by using the information included in the tunnel mapping and management table.

According to an aspect of the present invention, there is provided a gateway switch including: an interface unit that provides an interface to transmit/receive a packet; a packet processing unit that encapsulates a packet received from a certain terminal, which is to be transmitted to a counterpart node, by using a tunnel ID, and decapsulates a received packet, which is to be transmitted to the certain terminal, to remove a tunnel header; and a tunnel management unit that includes a tunnel mapping and management table, updates the tunnel mapping and management table if the certain terminal moves, and allocates a tunnel for transmitting/receiving a packet by using information included in the tunnel mapping and management table.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates the structure of a packet transport network system providing mobility of a mobile node in a packet transport network according to an exemplary embodiment of the present invention;

FIG. 2 illustrates a detailed structure of a gateway switch of the packet transport network system according to an exemplary embodiment of the present invention;

FIG. 3 illustrates a handover procedure and a data transmission procedure when handover occurs in the packet transport network according to an exemplary embodiment of the present invention; and

FIGS. 4a to 4d illustrate tunnel mapping and management tables for mobility to mobile nodes in a gateway switch of a packet transport access network according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

In describing the present invention, if a detailed explanation for a related known function or construction is considered to unnecessarily divert the gist of the present invention, such explanation will be omitted but would be understood by those skilled in the art.

In an exemplary embodiment of the present invention, a handover procedure in a system based on a packet transport network (referred to as a ‘packet transport network system’, hereinafter) and a method for providing mobility of a mobile node (MN) through a data transmission procedure will now be described. First, the structure of a packet transport network system will now be described in detail with reference to the accompanying drawings.

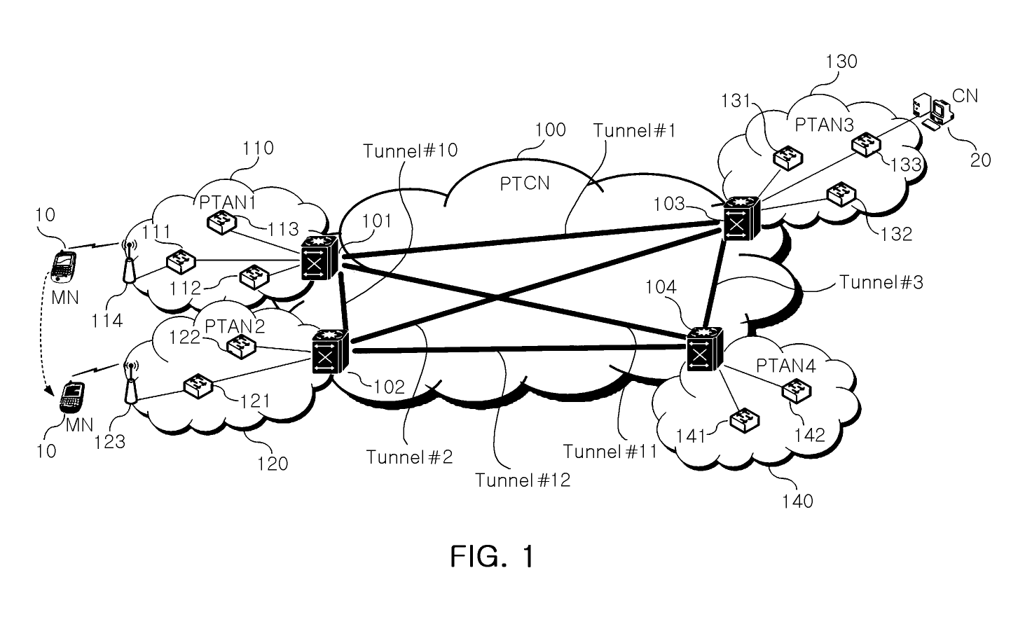

FIG. 1 illustrates the structure of the packet transport network system providing mobility of an MN in a packet transport network according to an exemplary embodiment of the present invention.

With reference to FIG. 1, the packet transport network includes a packet transport core network (PTCN) 100 and a plurality of packet transport access networks (PTANs) 110 to 140 connected to the PTCN 100.

The PTCN 100, logically having a mesh structure, serves to stably and reliably transfer packets tunneled from the packet transport network to a destination.

The PTANs 110 to 140 connected to the PTCN 100 each include a plurality of access switches and generally have a star or hierarchy structure. In addition, the PTCN 100 and the PTANs 100 to 140 are connected via gateway switches 101 to 104, respectively.

The packet transport network system for providing mobility of an MN in the packet transport network may include a plurality of MNs 10 and 20, wireless access points (APs) 114 and 123, a plurality of access switches 111 to 113, 121, 122, 131 to 133, and 141 and 142 configured in each of the PTANs 110 to 140, and the gateway switches 101 to 104 configured in the PTCN 100.

As shown in FIG. 1, the MN 110, one of the plurality of terminals, is connected to the wireless AP 114 of the first PTAN 110 to communicate with a counterpart node (CN) 20. When the MN 110 moves, it moves to the second PTAN 120 and is connected to the wireless AP 123 to perform communication with the CN 20. Here, the CN 20 is connected to the third PTAN 130.

The gateway switches 101 to 104 serve to generate and manage tunnels with counterpart gateway switches. The tunnels between the gateway switches 101 to 104 may be previously set by a manager at an early stage, and mutual mapping relationship between the pre-set tunnels and transmitted packets will be described in detail in a method described later.

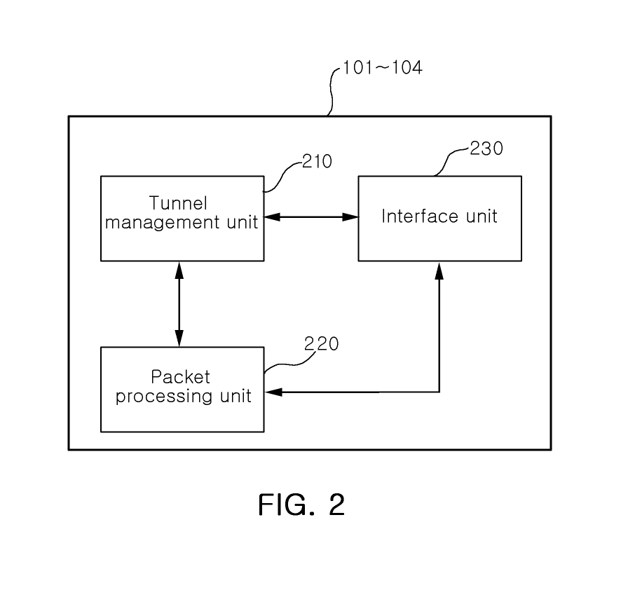

As shown in FIG. 2, each of the gateway switches 101 to 104 may include a tunnel management unit 210, a packet processing unit 220, and an interface unit 230.

The tunnel management unit 210 includes a tunnel mapping and management table. When the MN 10 moves, the tunnel management unit 210 updates the tunnel mapping and management table and allocates a tunnel for transmitting/receiving a packet by using information included in the tunnel mapping and management table. Also, the tunnel management unit 210 adds a new medium access control (MAC) address to a pre-set tunnel in the tunnel mapping and management table for communication with the CN 20, additionally registers a virtual LAN ID (VID), and deletes the MAC address from the existing tunnel in the tunnel mapping and management table.

When the packet processing unit 220 receives a packet from the MN 10, which is to be transmitted to the CN 20, it encapsulates the received packet by using a tunnel ID, and when the packet processing unit 220 receives a packet to be transmitted to the MN 10, it decapsulates the received packet to remove a tunnel header. In detail, the packet processing unit 220 selects the tunnel ID by using the VID and the MAC address included in the tunnel mapping and management table managed by the packet processing unit 220 itself, and encapsulates the received packet by using the selected tunnel ID.

The interface unit 230 provides an interface for packet transmission/reception. Namely, the interface unit 230 provides an interface with the plurality of access switches included in the PTANs 110 to 140 connected to the MNs 10 and 20 to connect the PTCN 100 and the PTANs 110 to 140, and transmits/receives a packet via a pre-set tunnel.

The handover procedure and a procedure for a data transmission process in case of the terminal movement in the packet transport network according to an exemplary embodiment of the present invention will now be described.

The MN 10 connected to the wireless AP 114 of the first PTAN 110 to perform communication with the CN 20 transfers a packet to the first gateway switch 101 connected to the first PTAN 110. Upon receiving the packet, the first gateway switch 101 allocates a pre-set first tunnel (Tunnel #1) with reference to a MAC address of a source and destination of the received packet and a virtual LAN ID (VID).

Thereafter, the first gateway switch 101 encapsulates the packet and transmits it to the third gateway 103 connected to the CN 20. Upon receiving the packet, the third gateway switch 103 removes a tunneling header and transfers the packet to the CN 20, a final destination, via the destination MAC address and the VID. In this case, if the MN 10 moves to the adjacent second PTAN 120 during communication with the CN 20, handover occurs between the previous wireless AP 114 and the new wireless AP 123.

Then, the MN 10 and the CN 20 change the existing first tunnel (Tunnel #1), through which they transmit/receive packets, to a new second tunnel (Tunnel #2), and transmit/receive packets through the new second tunnel (Tunnel #2) without interrupting a corresponding service. The handover procedure performed according to the movement of the MN 10 and the tunnel updating process will now be described in detail with reference to the accompanying drawings.

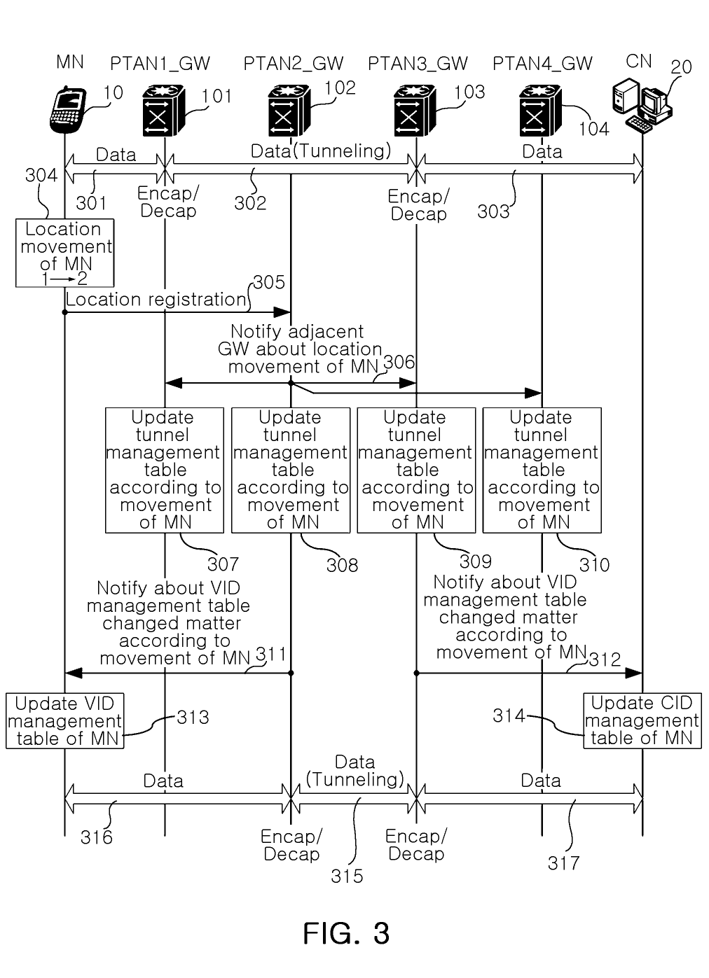

FIG. 3 illustrates a handover procedure and a data transmission procedure when handover occurs in the packet transport network according to an exemplary embodiment of the present invention.

With reference to FIG. 3, in step S301, the MN 10 transmits a packet (data) to a first gateway switch (packet transport access network gateway switch 1 (PTAN1_GW)) 101 of the first PTAN 110. In step S302, the first gateway switch 101 encapsulates the received packet by using a tunneling header and transmits the packet via the first tunnel (Tunnel #1) between the first gateway switch 101 and the third gateway switch (PTAN3_GW) 103 of the third PTAN 130. In step S303, upon receiving the encapsulated packet from the first gateway switch 101, the third gateway switch 103 decapsulates the packet, removes a tunneling header from the decapsulated packet, and transmits the tunneling header-removed packet to the CN 20, a destination, according to a general L2 forwarding method. Accordingly, the MN 10 and the CN 20 transmit/receive packets via the first tunnel (Tunnel #1) between the first and third gateway switches 101 and 103.

In step S304, in the case where the MN 10 moves to the adjacent second PTAN 120 during communication with the CN 20, in step S305, the MN 10 notifies the second gateway switch 102 of the second PTAN 120 about its movement through L2 triggering, and registers its location.

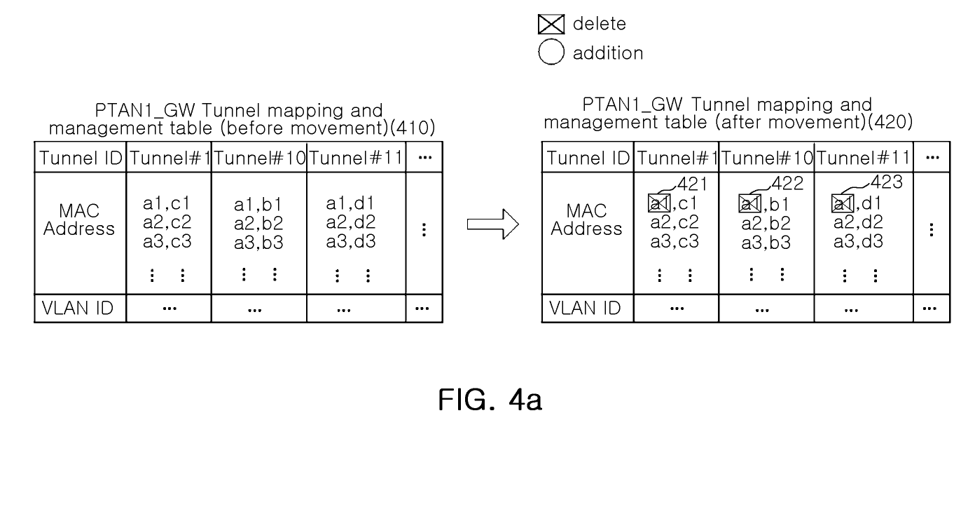

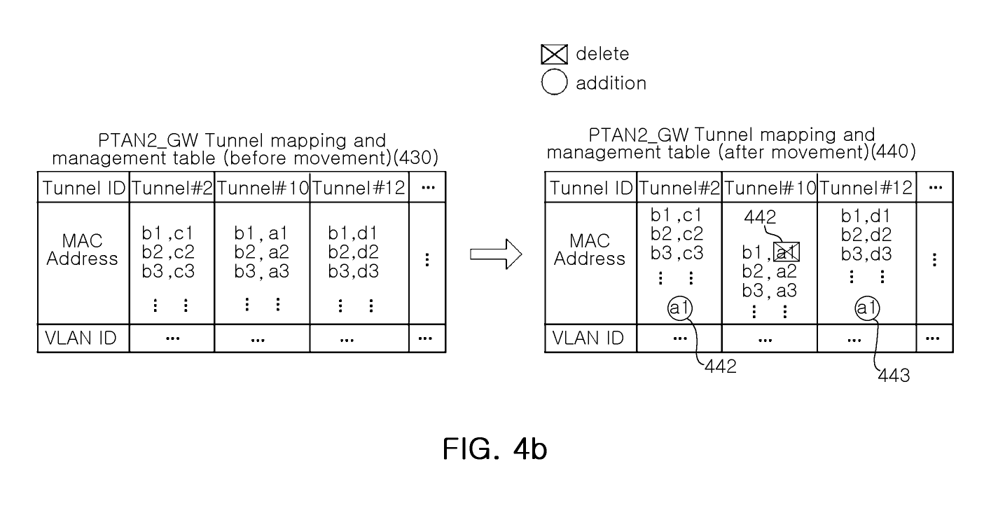

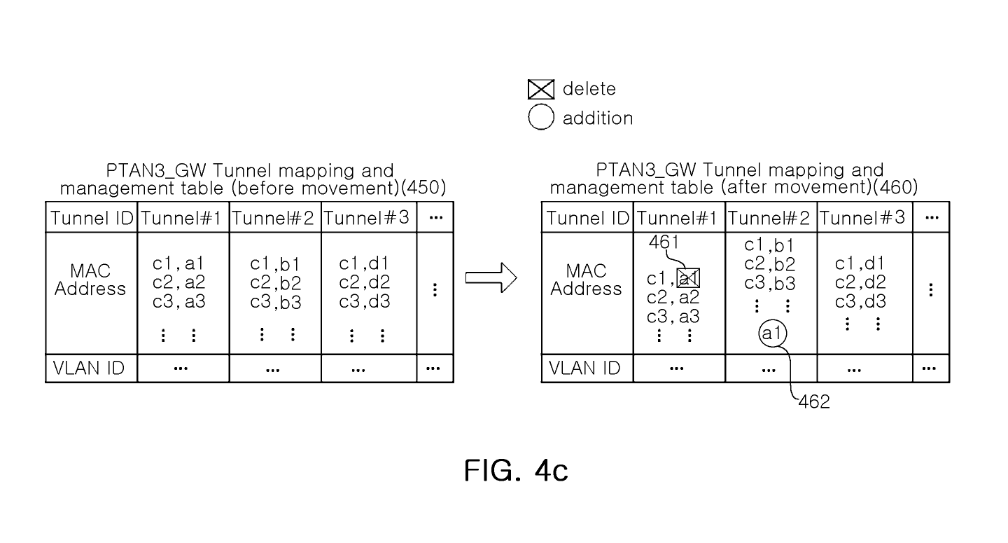

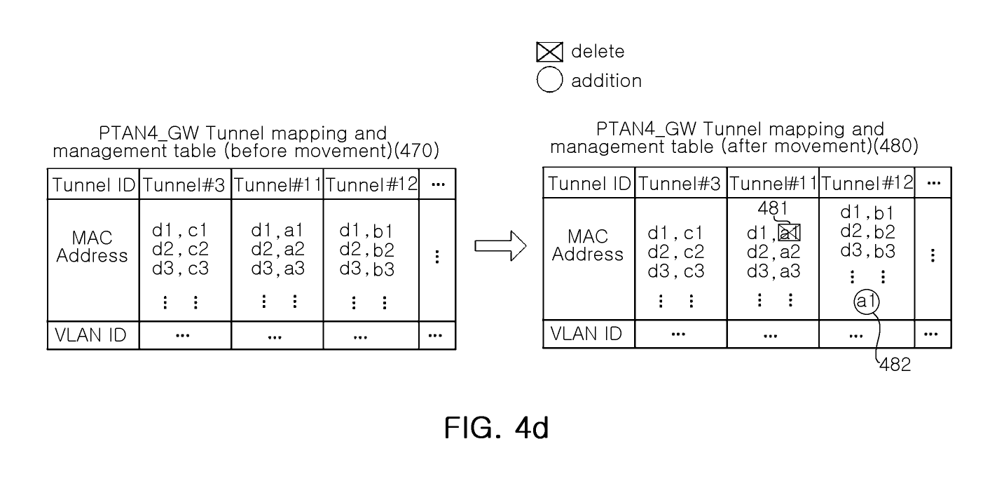

Then, in step S306, upon being notified about the location registration of the MN 10, the second gateway switch 102 notifies the other adjacent gateway switches 101, 103, and 104 that the MN 10 has moved to the new second PTAN 120 from the previous first PTAN 110. Accordingly, insteps S307 to S310, upon being notified about the movement of the MN 10, the gateway switches 101 to 104 update their tunnel management table according to the movement of the MN 10. Here, updating of the tunnel management table will be described later with reference to FIG. 4.

Thereafter, in step S311, if necessary, the second gateway switch 102 notifies the MN 10 about a changed matter of a VID management table according to the movement of the MN 10. Accordingly, in step S313, the MN 10 updates its VID management table. At the same time, in step S312, the third gateway switch 103 notifies the CN 20 about the changed matter of the VID management table according to the movement of the MN 10, if necessary. Accordingly, in step S314, the CN 20 updates its VID management table.

In steps S307 to S310, the tunnel management table is updated, and in steps S315 to S317, the MN 10 transfers a packet to the second gateway switch PTAN2_GW 102, and the second gateway switch PTAN2_GW 102 establishes the second tunnel (Tunnel #2) with the third gateway switch PTAN3_GW 103 to transmit the packet to the CN 20 via the second tunnel (Tunnel #2) and via the third gateway switch PTAN3_GW 103. Likewise, in steps S313 to S315, a packet of the CN 20 is transferred to the third gateway switch PTAN3_GW 103, transmitted to the second gateway switch PTAN2_GW 102 via the new second tunnel (Tunnel #2), instead of the previous first tunnel (Tunnel #1), its tunneling header is removed by the second gateway switch PTAN2_GW 102, and then transferred to the MN 10.

FIGS. 4a to 4d illustrate tunnel mapping and management tables for mobility of a mobile node in a gateway switch of the PTAN according to an exemplary embodiment of the present invention.

As shown in FIGS. 4a to 4d, the tunnel mapping and management tables 410 to 480 are tunnel management tables for logically mapping the source and destination MAC addresses, the VID, and the logical tunnels, including information about a tunnel ID, a MAC address, and a VID. The tunnel mapping and management tables are managed by the gateway switches 101 to 104.

The tunnels between the gateway switches 101 to 104 may be previously set by a manager at an early stage, and a tunnel interface according to the MAC address and the VID is provided through the tunnel mapping and management tables 410 to 480.

When the terminal nodes having the MAC address and the VID transmit a packet, they transfers the packet to a gateway switch of a PTAN to which they belong. When the gateway switch receives the packet, it selects a tunnel ID with reference to the MAC address and the VID according to the tunnel mapping and management tables 410 to 480, encapsulates the packet, and transmits the encapsulated packet to a gateway switch of a counterpart PTAN. Here, the MAC address and VID mapped to the tunnel ID follow IEEE802.1Q (Virtual LAN) standard, and if the number of tunnels exceeds a maximum value (4,096), it may be extended to a combination of user VIDs (Customer VID (C-VID)) and a service VID (S-VID) according to IEEE802.1ad (Q-in-Q).

The process of updating the tunnel mapping and management tables of the gateway switches 101 to 104 when the MN 10 moves from the first PTAN 110 to the adjacent second PTAN 120 will now be described with reference to FIGS. 4a to 4d.

As shown in FIGS. 4a to 4d, it is assumed that MAC addresses of a1, a2, a3, . . . are registered for the first PTAN 110, MAC addresses of b1, b2, b3 . . . are registered for the second PTAN 120, MAC addresses of c1, c2, c3 . . . are registered for the third PTAN 130, and MAC addresses of d1, d2, d3 . . . are registered for the fourth PTAN 140. When the VID grouped for each MAC address exists in the tables and the tunnel IDs between the gateway switches 101 to 104 are set as shown in FIG. 1, the tunnel mapping and management tables previously set at the gateway switches 101 to 104 are 410, 430, 450, and 460 as shown in FIGS. 4a to 4d.

Accordingly, when the MN 10 communicates with the CN 20, because the CN 20 has been registered to the third PTAN 130, it has one of the MAC address of c1, c2, c3 . . . .

The MN 10 and the CN 20 are allocated the first tunnel by the tunnel mapping and management table 410 with reference to the MAC address and the VID and transmit/receive a packet therethrough. Thereafter, when the MN 10 moves to the second PTAN 120, as shown in steps S304 to S306 in FIG. 3, the second gateway switch 102 additionally registers the MAC address and VID of the MN 10 according to a registration request of the MN 10 and notifies the adjacent gateway switches 101, 103, and 104 accordingly. At this time, before the MN 10 moves, the tunnel mapping and management table 430 of the second gateway switch 102 adds a new MAC address a1 to the second tunnel (Tunnel #2) and a 12^{th} tunnel (Tunnel #12) (441, 443) and deletes a1 from an existing tenth tunnel (Tunnel #10) (442), so as to be updated to the tunnel mapping and management table 440 after the movement of the MN 10.

Likewise, as shown in step S307 in FIG. 3, upon being notified about the movement of the MN 10, the adjacent first gateway switch 101 deletes the MAC address a1 from each tunnel ID (421, 422, 423) because the MAC address a1 does not exist in its network any longer, thus updating the tunnel mapping and management table 410 before the movement of the MN to the tunnel mapping and management table 420 after the movement of the MN 10.

In the same manner, as shown in step S309 in FIG. 3, upon being notified about the movement of the MN 10, the adjacent third gateway switch 103 deletes the MAC address a1 from the first tunnel (Tunnel #1) (461) and adds it to the new second tunnel (Tunnel #2) (462), thereby updating the tunnel mapping and management table 450 before the movement of the MN to the tunnel mapping and management table 460 after the movement of the MN 10.

Finally, as shown in step S310 in FIG. 3, upon being notified about the movement of the MN 10, the adjacent fourth gateway switch 104 deletes the MAC address a1 from an 11th tunnel (Tunnel #11) (481) and adds it to the new 12th tunnel (Tunnel #12) (482), thereby updating the tunnel mapping and management table 470 before the movement of the MN to the tunnel mapping and management table 480 after the movement of the MN 10.

When the updating process is completed as described above, the MN 10 and the CN 20 tunnel a packet via the new second tunnel (Tunnel #2), not via the previous first tunnel (Tunnel #1) according to the updated tunnel mapping and management table 440, 460.

As set forth above, according to exemplary embodiments of the invention, because a tunnel is set and managed by a gateway switch connecting a packet transport core and metro network and a plurality of local area packet transport access networks in a packet transport network, a packet loss and delay due to the influence of handover generated as a terminal moves between networks can be minimized and the handover procedure can be simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for providing mobility of a mobile node by a gateway switch of one of a plurality of packet transport access networks each having a gateway switch to be connected to a core network in a packet transport network, the method including:
transmitting/receiving a packet between the mobile node and a counterpart node via a first tunnel established with a gateway switch of a packet transport access network in which the counterpart node is located;
transmitting a packet received via the first tunnel from the counterpart node to the mobile node;
setting and managing a logical tunnel mapping and management table between different gateway switches according to the movement of the mobile node;
establishing a second tunnel between a gateway switch of an adjacent packet transport access network to which the mobile node has moved and the gateway switch of the packet transport access network in which the counterpart node is located; and
transmitting/receiving a packet between the mobile node and the counterpart node via the established second tunnel.

2. The method of claim 1, wherein the transmitting/receiving of a packet between the mobile node and the counterpart node via the first tunnel comprises:
establishing the first tunnel with the gateway switch of the packet transport access network in which the counterpart node is located;
when a packet is received from the mobile node, encapsulating the received packet by using a tunnel ID; and
transmitting the encapsulated packet to the counterpart node via the first tunnel.

3. The method of claim 2, wherein the encapsulating of the received packet by using the tunnel ID when the packet is received from the mobile node, comprises:
selecting the tunnel ID by using a virtual LAN ID (VID) and a medium access control (MAC) address included in the tunnel mapping and management table; and
encapsulating the received packet by using the selected tunnel ID.

4. The method of claim 1, wherein the transmitting/receiving of a packet between the mobile node and the counterpart node via the first tunnel comprises:
when a packet is received from the counterpart node via the first tunnel, decapsulating the received packet; and
removing a tunnel header from the decapsulated packet and transmitting the tunnel header-removed packet to the mobile node.

5. The method of claim 1, wherein the setting and managing of the logical tunnel mapping and management table comprises:
when the mobile node moves to an adjacent packet transport access network, registering, by the mobile node, its location to a gateway switch of the adjacent packet transport access network; and
updating the tunnel mapping and management table.

6. The method of claim 1, wherein the setting and managing of the logical tunnel mapping and management table comprises:
when the mobile node receives a request for location registration from the gateway switch of the packet transport access network in which the mobile node was previously located, updating the tunnel mapping and management table;
notifying adjacent different gateway switches about the location movement of the mobile node; and
notifying the mobile node and the counterpart node about the changed matter.

7. The method of claim 6, wherein the updating the tunnel mapping and management table comprises:
adding a new MAC address to a pre-set tunnel in the tunnel mapping and management table for communication with the counterpart node, additionally registering a virtual LAN ID (VID), and deleting the MAC address from the existing tunnel of the tunnel mapping and management table.

8. The method of claim 1, wherein the transmitting/receiving a packet between the mobile node and the counterpart node via the established second tunnel, comprises:
when a packet is received from the mobile node, encapsulating the received packet by using a tunnel ID; and
transmitting the encapsulated packet to the counterpart node via the second tunnel.

9. The method of claim 8, wherein the encapsulating of the received packet by using the tunnel ID when the packet is received from the mobile node, comprises:
selecting the tunnel ID by using a virtual LAN ID (VID) and a medium access control (MAC) address included in the tunnel mapping and management table; and
encapsulating the received packet by using the selected tunnel ID.

10. The method of claim 1, wherein the transmitting/receiving of a packet between the mobile node and the counterpart node via the second tunnel comprises:
when a packet is received from the counterpart node via the second tunnel, decapsulating the received packet; and
removing a tunnel header from the decapsulated packet and transmitting the tunnel header-removed packet to the mobile node.

11. A packet transport network system comprising:
a plurality of access switches configured in a plurality of packet transport access networks connected to a packet transport core network and transmitting/receiving a packet to/from a certain terminal; and
a plurality of gateway switches configured in the plurality of packet transport access networks, connecting the packet transport access networks to the packet transport core network, and transmitting/receiving a packet to/from the certain terminal via a certain access switch,
wherein each gateway switch includes a tunnel mapping and management table, and when the certain terminal moves, each gateway switch updates the tunnel mapping and management table according to the movement of the certain terminal and allocates a tunnel for transmitting/receiving a packet to/from a counterpart node by using the information included in the tunnel mapping and management table.

12. The system of claim 11, wherein each gateway switch adds a new medium access control (MAC) address to a pre-set tunnel in the tunnel mapping and management table for communication with the counterpart node, additionally registers a virtual LAN ID (VID), and deletes the MAC address from an existing tunnel of the tunnel mapping and management table.

13. The system of claim 11, wherein when each gateway switch receives a packet, which is to be transmitted to a counterpart node, from a certain terminal, it encapsulates the received packet by using a tunnel ID, and when each gateway switch receives a packet to be transmitted to the certain terminal, it decapsulates the received packet and removes a tunnel header from the decapsulated packet.

14. The system of claim 13, wherein each gateway switch selects the tunnel ID by using the MAC address and the VID included in its tunnel mapping and management table, and encapsulates the received packet by using the selected tunnel ID.

15. A gateway switch comprising:
an interface unit that provides an interface to transmit/receive a packet;
a packet processing unit that encapsulates a packet received from a certain terminal, which is to be transmitted to a counterpart node, by using a tunnel ID, and decapsulates a received packet, which is to be transmitted to the certain terminal, and removes a tunnel header from the decapsulated packet; and
a tunnel management unit that includes a tunnel mapping and management table, updates the tunnel mapping and management table if the certain terminal moves, and allocates a tunnel for transmitting/receiving a packet by using information included in the tunnel mapping and management table.

16. The gateway switch of claim 15, wherein the packet processing unit selects the tunnel ID by using a MAC address and a VID included in its tunnel mapping and management table, and encapsulates the received packet by using the selected tunnel ID.

17. The gateway switch of claim 15, wherein the tunnel management unit adds a new medium access control (MAC) address to a pre-set tunnel in the tunnel mapping and management table for communication with the counterpart node, additionally registers a virtual LAN ID (VID), and deletes the MAC address from an existing tunnel of the tunnel mapping and management table.
